(19) United States
(12) Patent Application Publication
(10) Pub. No.: US 2015/0243415 A1
(43) Pub. Date: Aug. 27, 2015

(54) Method for manufacturing NdFeB rare earth permanent magnet containing Ce

(71) Applicant: SHENYANG GENERAL MAGNETIC CO., LTD., Shenyang (CN)

(72) Inventor: Baoyu Sun, Shenyang (CN)

(73) Assignee: SHENYANG GENERAL MAGNETIC CO., LTD

(21) Appl. No.: 14/709,021

(22) Filed: May 11, 2015

(30) Foreign Application Priority Data
May 11, 2014 (CN) 201410195418.2

(51) Int. Cl. H01F 1/057; H01F 1/055; C22C 38/16; C22C 38/10; C22C 38/12; C22C 38/06; C22C 38/00; H01F 41/02; C22C 38/14

(52) U.S. Cl. CPC H01F 1/057; H01F 41/0266; H01F 41/0293; H01F 1/0556; H01F 1/0557; C22C 38/16; C22C 38/14; C22C 38/12; C22C 38/06; C22C 38/002; C22C 38/10; C22C 38/005

(57) ABSTRACT

A method for manufacturing a NdFeB rare earth permanent magnet containing Ce whose raw material includes a Ce-LR-Fe—B-Ma alloy, a Ce-HR-Fe—B-Mb alloy, and metallic oxide micro-powder; wherein the LR at least includes Nd and Pr, and the LR does not include Ce; wherein the HR at least includes Dy or Tb, and the HR does not include Ce; wherein the Ma is selected from a group consisting of Al, Co, Nb, Ga, Zr and Cu; wherein the Mb is selected from a group consisting of Al, Co, Nb, Ga, Zr, Cu and Mo; includes steps of: melting the Ce-LR-Fe—B-Ma alloy, melting the Ce-HR-Fe—B-Mb alloy, providing hydrogen decrepitating, adsorbing with the metallic oxide micro-powder and powdering, providing magnetic field pressing, sintering and ageing, for forming a NdFeB rare earth permanent magnet.

### CROSS REFERENCE OF RELATED APPLICATION

The present invention claims priority under 35 U.S.C. 119(a-d) to CN 201410195418.2, filed May 11, 2014.

### BACKGROUND OF THE PRESENT INVENTION

1. Field of Invention

The present invention relates to a field of permanent magnetic materials, and more particularly to a method for manufacturing a NdFeB rare earth permanent magnet containing Ce.

2. Description of Related Arts

NdFeB rare earth permanent magnets are more and more widely used due to excellent magnetic properties thereof. For example, the NdFeB rare earth permanent magnets are widely used in medical nuclear magnetic resonance imaging, computer hard disk drivers, stereos, cell phones, etc. With the requirements of energy efficiency and low-carbon economy, the NdFeB rare earth permanent magnets are also used in fields such as automobile parts, household appliances, energy conservation and control motors, hybrid cars and wind power.

In 1983, Japanese patents No. 1,622,492 and No. 2,137,496 firstly disclosed a NdFeB rare earth permanent magnet invented by Japanese Sumitomo Metals Industries, Ltd., which disclose features, components and manufacturing methods of the NdFeB rare earth permanent magnets, and confirm that a main phase is a Nd₂Fe₁₄B phase and a grain boundary phase comprises a rich Nd phase, a rich B phase and rare earth oxidants. NdFeB rare earth permanent magnets are widely used because of sufficient magnetic performance, and are called the king of permanent magnets. U.S. Pat. No. 5,645,651, authorized in 1997, further disclosed adding Co and the main phase having a square structure.

With wide application of the NdFeB rare earth permanent magnets, rare earth is more and more rare. Especially, shortage of heavy rare earth element resource is significant, and price of the rare earth is continuously increasing. Therefore, after a lot of searching, double-alloy technology, metal infiltration technology, grain boundary improving or recombining technology, etc. appear. Chinese patent CN101521069B discloses a NdFeB manufacturing technology doped with heavy rare earth hydride nano-particles, wherein alloy flakes are firstly manufactured with strip casting technology, then powder is formed by hydrogen decrepitating and jet milling, the above power is mixed with heavy rare earth hydride nano-particles formed by physical vapor deposition technology, and then NdFeB magnet is manufactured through conventional processes such as magnetic field pressing and sintering. Although the Chinese patent discloses a method to enhance coercivity of magnet, there is problem for mass production.

Chinese CN1688000 discloses a method for increasing sintered NdFeB coercivity by adding nano oxide into grain boundary phase, which is improvement of double-alloy method, wherein firstly, respectively molding or strip casting flaking main phase alloy and a grain boundary phase for producing a NdFeB alloy ingot or producing a strip casting alloy flake; crashing with hydrogen decrepitation or crusher, then jet milling for respectively producing 2-10 μm powder; adding 2-20% decentralized nano oxide and 1-10% antioxidant into the grain boundary phase powder, evenly mixing in a mixer; then mixing the mixture of the nano oxide and the grain boundary phase powder with the main alloy powder, wherein an amount of the grain boundary phase powder is 1-20% of a total weight; meanwhile, adding 0.5-5% gasoline and mixing in the mixer for producing mixed powder; pressing the mixed powder under 1.2-2.0 T magnetic field for producing a sintered NdFeB magnet. According to the present invention, a core technology is: by evenly distributing the nano oxide in the grain boundary phase, the coercivity of the NdFeB magnet is increased by modifying the grain boundary phase. According to the present invention, the main phase and the grain boundary phase are respectively melted, powdered, and mixed for many times. Because NdFeB fine powder is very easy to be oxidized, the technology is complex and is not easy to be controlled. In addition, when melting the main phase alloy, α-Fe is easy to be generated due to a low rare earth content and a compound similar to Nd₂Fe₁₄B, which will lower residual magnetism. When melting the grain boundary phase, main phase is easy to be generated, which will decrease the coercivity. Because of a large surface area of the nano oxide, explosion risk exists during transporting and using. Producing nano oxide is difficult and expensive, which restricts application of NdFeB.

### SUMMARY OF THE PRESENT INVENTION

After researches, the present invention provides a method for manufacturing a NdFeB rare earth permanent magnet containing Ce, which overcomes defects of the conventional technology, and significantly improves magnetic energy product, coercivity, anti-corrosion and processing property of NdFeB rare earth permanent magnet. The method is suitable for mass production and uses less heavy rare earth elements which are expensive and rare. The method is important for widening application of NdFeB rare earth permanent magnets, especially in fields such as energy conservation and control motors, automobile parts, hybrid cars and wind power. The present invention also discloses that magnetic energy product, coercivity, anti-corrosive ability and processing performance are improved, and grain growth is inhibited. Especially, if Ce is added, Ce oxide micro-particle is generated in the grain boundary phase. The Ce oxide micro-particle effectively inhibits abnormal grain growth during sintering, and forms a composite main phase structure with a core of a PR₂(Fe_{1-x-y}CoₓAl_{y})₁₄B phase, and a ZR₂(Fe_{1-w-n}Co_{w}Alₙ)₁₄B main phase surrounding a periphery of the PR₂(Fe_{1-x-y}CoₓAl_{y})₁₄B main phase, wherein there is no grain boundary phase therebetween.

A NdFeB rare earth permanent magnet containing Ce is provided, wherein the NdFeB rare earth permanent magnet has a composition comprising Ce 0-9 wt. %; Ra 19-32 wt. %; B 0.8-1.2 wt. %; M 0-4.0 wt. %; Rb 0.5-10 wt. %; Ce+Ra+Rb 30-33 wt. %; Fe and impurity;

wherein the Ra comprises at least two rare elements selected from a group consisting of Ce, Pr and Nd, and the Ra at least comprises Nd;

the Rb is selected from a group consisting of Dy, Tb, Ho and Gd;

the M is selected from a group consisting of Al, Co, Nb, Ga, Zr, Cu and Mo;

wherein the Ra comprises a rare earth element Pr and a rare earth element Nd, and Pr/Nd is 0.25-0.45.

A content of Al is: 0.1≦Al≦0.9, preferably 0.2≦Al≦0.5.

A content of Co is: 0≦Co≦5, preferably 0.8≦Co≦2.4.

A content of Cu is: 0≦Cu≦0.5, preferably 0.1≦Cu≦0.2.

A content of Ga is: 0≦Ga≦0.3, preferably 0.1≦Ga≦0.2.

A content of Nb is: 0≦Nb≦0.9, preferably 0.1≦Nb≦0.6.

A content of Zr is: 0≦Zr≦0.5, preferably 0.05≦Zr≦0.2.

The NdFeB rare earth permanent magnet containing Ce comprises a composite main phase and a grain boundary phase, wherein the composite main phase has a core of a PR₂(Fe_{1-x-y}CoₓAl_{y})₁₄B phase; a ZR₂(Fe_{1-w-n}Co_{w}Alₙ)₁₄B main phase surrounds the PR₂(Fe_{1-x-y}CoₓAl_{y})₁₄B main phase, and there is no grain boundary phase therebetween; wherein the ZR refers to a group of main phase rare earth elements whose heavy rare earth contents are higher than an average heavy rare earth content; the PR refers to a group of main phase rare earth elements whose heavy rare earth contents are lower than the average heavy rare earth content; wherein 0≦x≦0.3, 0≦y≦0.2, 0≦w≦0.3, 0≦n≦0.2; Ra oxide micro-particles and oxidized Nd micro-particles exist in the grain boundary phase; and an oxygen content of the grain boundary phase is higher than an oxygen content of the main phase.

According to experiments, the less w and n are, the higher magnetic performance will be. The magnetic performance reaches a max value when w=0 and n=0, which means that when a core PR₂(Fe_{1-x-y}CoₓAl_{y})₁₄B main phase is PR₂Fe₁₄B, performance is best.

The NdFeB rare earth permanent magnet containing Ce comprises the composite main phase and the grain boundary phase, and an average grain size is 3-15 μm, preferably 5-7 μm.

Oxidized Ce micro-particles and oxidized Nd micro-particles exist in the grain boundary phase of the NdFeB rare earth permanent magnet containing Ce.

Oxidized Ce₂O₃ micro-particles and oxidized Nd₂O₃ micro-particles exist in the grain boundary phase of the NdFeB rare earth permanent magnet containing Ce.

Oxidized Ce micro-particles and oxidized Nd micro-particles exist at a boundary of more than two ZR₂(Fe_{1-w-n}Co_{w}Alₙ)₁₄B phase grains of the NdFeB rare earth permanent magnet containing Ce.

Accordingly, the present invention provides a method for manufacturing the NdFeB rare earth permanent magnet containing Ce:

wherein a raw material comprises a Ce-LR-Fe—B-Ma alloy, a Ce-HR-Fe—B-Mb alloy, and metallic oxide micro-powder; the LR at least comprises Nd and Pr; the Ma is selected from a group consisting of Al, Co, Nb, Ga, Zr and Cu; the Mb is selected from a group consisting of Al, Co, Nb, Ga, Zr, Cu and Mo; the HR at least comprises Dy; preferably, the metallic oxide micro-powder does not comprise lanthanum oxide and cerium oxide, and is selected from a group consisting of Al, Co, Nb, Ga, Zr, Cu, V, Mo, Fe and Zn metallic oxide; preferably, the metallic oxide is selected from a group consisting of Dy₂O₃, Tb₂O₃ and Al₂O₃.

Preferably, the LR is selected from a group consisting of Nd, Pr, La, Gd and Ho; more preferably, the LR comprises Nd and Pr; even more preferably, the LR comprises Nd and Pr, wherein Nd is 74-81%, and Pr is 26-19%; when the LR comprises Nd and Pr, residual magnetism and magnetic energy product of the magnet are highest, and when Nd is 74-81% and Pr is 26-19%, cost is lowest.

Preferably, the Ma comprises Al, Co and Cu; more preferably, the Ma is Al; even more preferably, the Ma does not appear, which means that the Ce-LR-Fe—B-Ma alloy is transformed to a Ce—Lr—Fe—B alloy; when the Ma is decreased in the Ce-LR-Fe—B-Ma alloy, residual magnetism and magnetic energy product of the NdFeB magnet are increased, resulting in poor process stability; without the Ma, residual magnetism and magnetic energy product are highest.

Preferably, the Mb comprises Al, Co, Nb, Ga, Zr, Cu and Mo; more preferably, the Mb is selected from a group consisting of Al, Co, Nb, Ga, and Cu; even more preferably, the Mb comprises Al, Co, Ga, Zr and Cu; extremely preferably, the Mb comprises Al, Co, Ga and Cu; when the Mb of a HR-Fe—B-Mb comprises Al, Co, Ga and Cu, Ce-HR-Fe—B-Mb alloy grains are refined, and magnetic performance and anti-corrosive ability of the magnet are sufficient; when the Mb comprises Al, Co, Ga, Zr and Cu, the Ce-HR-Fe—B-Mb alloy grains are further refined and grain boundaries are evenly distributed; when the Mb comprises Al, Co, Nb, Ga, Zr and Cu, the Ce-HR-Fe—B-Mb alloy grains are further improved, and grain boundary distribution is optimized.

When the metallic oxide micro-powder is Tb₂O₃, magnetic performance is best. When the metallic oxide micro-powder is Dy₂O₃, magnetic performance is secondly best. When Al₂O₃ is added to Dy₂O₃, magnetic performance is lowered but anti-corrosive ability is best. When Tb₂O₃, Dy₂O₃ and Al₂O₃ are all added, magnetic performance is increased while cost is lowered, and anti-corrosive ability is increased. Preferably, a particle size of the micro-powder is less than 2 μm; more preferably, 20-100 nm; even more preferably, 0.5-1 μm. By adding the metallic oxide micro-powder, during powdering with jet milling, the metallic oxide micro-powder is further crashed and is adsorbed on surfaces of the grain boundary phase and the main phase. Because combining power between the La and oxygen is highest during sintering, under a certain temperature and vacuum degree, the La is preferentially combined with oxygen for forming the oxidized La micro-particle. Metal elements displaced from the metallic oxide micro-powder enter or surround the main phase, which significantly increases coercivity and anti-corrosive ability of the magnet. Without the La, a combining order with oxygen is: Ce, Pr, and then Nd.

The method comprises steps of:

(1) melting the Ce-LR-Fe—B-Ma alloy which comprises:

melting a Ce—La-LR-Fe—B-Ma raw material under vacuum or argon protection with induction heating for forming an alloy, refining before casting the alloy in a melted state onto a rotation roller with a water cooling function through a tundish, and cooling the melted alloy with the rotation roller for forming alloy flakes, wherein an average grain size of each of the alloy flakes is 1.5-3.5 μm;

(2) melting the Ce-HR-Fe—B-Mb alloy which comprises:

melting a Ce-HR-Fe—B-Mb raw material under vacuum or argon protection with induction heating for forming an alloy, refining before casting the alloy in a melted state onto a rotation roller with a water cooling function through a tundish, and cooling the melted alloy with the rotation roller for forming alloy flakes, wherein an average grain size of each of the alloy flakes is 0.1-2.9 μm;

(3) providing hydrogen decrepitating which comprises:

sending the Ce-LR-Fe—B-Ma alloy and the Ce-HR-Fe—B-Mb alloy into a vacuum hydrogen decrepitation device, evacuating before inputting hydrogen for hydrogen absorption, wherein a hydrogen absorption temperature is 100-300° C.; heating after hydrogen absorption and evacuating for dehydrogenating, wherein a dehydrogenating temperature is 350-900° C., a dehydrogenating time is 3-15 h, then cooling the alloys;

after vacuum dehydrogenation, inputting hydrogen with a pre-determined amount within a temperature range of 100-600° C., then cooling the alloys;

(4) adsorbing with the metallic oxide micro-powder and powdering which comprises:

adding the Ce-LR-Fe—B-Ma alloy treated with hydrogen decrepitating, the Ce-HR—Fe—B-Mb alloy treated with hydrogen decrepitating and the metallic oxide micro-powder into a mixer for mixing, wherein lubricant and anti-oxidant may be added, mixing is provided under nitrogen protection with a mixing time of more than 30 min; powdering jet milling after mixing, wherein an average particle size of the powder is 1-3.3 μm;

wherein hydrogen with the pre-determined amount may be inputted during adding the Ce-LR-Fe—B-Ma alloy treated with hydrogen decrepitating, the Ce-HR-Fe—B-Mb alloy treated with hydrogen decrepitating and the metallic oxide micro-powder into a mixer for mixing;

wherein the powdering with jet milling may be provided under nitrogen protection, wherein after mixing, adding powder into a hopper on a top portion of a feeder, moving the pre-mixed powder into a milling room through the feeder, milling with high-speed flow from a spray nozzle, wherein the powder milled rises with the flow and enters a cyclone collector through a sorting wheel for collecting; some fine powder wrapped by the metallic oxide micro-powder is outputted with gas flow from an outputting pipeline of the cyclone collector and is collected in a collector behind the cyclone collector; then mixing under nitrogen protection for obtaining the alloy powder; and

(5) providing magnetic field pressing, sintering and ageing which comprises:

processing the alloy powder with magnetic field pressing under nitrogen protection; then sintering and ageing under vacuum or argon protection for producing the NdFeB rare earth permanent magnet;

wherein during the magnetic field pressing, sending the alloy powder into a nitrogen protection sealed magnetic field pressing machine under the nitrogen protection, weighting before adding to a cavity of a mould already assembled, then providing magnetic field pressing; after pressing, returning the mould to a powder feeder, opening the mould and obtaining a magnetic block; wrapping the magnetic block with a plastic or rubber bag under the nitrogen protection; sending into an isostatic pressing machine for isostatic pressing, and then directly sending the magnetic block which is still wrapped into a nitrogen protection loading tank of a vacuum sintering furnace; unwrapping the magnetic block with gloves in the nitrogen protection loading tank and sending to a sintering case;

wherein during sintering and ageing, sending the sintering case in the nitrogen protection loading tank of the vacuum sintering furnace into a heating chamber of the vacuum sintering furnace, evacuating before heating, heating with a temperature of 200-400° C. for 2-10 h, then heating with a temperature of 400-600° C. for 5-12 h, and then heating with a temperature of 600-1050° C. for 5-20 h for pre-sintering; after pre-sintering, heating with a temperature of 950-1070° C. for 1-6 h for sintering; after sintering, firstly ageing at 800-950° C. and secondly ageing at 450-650° C.; after secondly ageing, rapidly cooling for forming a sintered NdFeB permanent magnet; machining and surface-treating the NdFeB permanent magnet for forming a rare earth permanent device.

After pre-sintering, a density of the magnet is 7-7.4 g/cm³. After sintering, a density of the magnet is 7.5-7.7 g/cm³.

Preferably, according to the method, the metallic oxide micro-powder is Dy₂O₃ micro-powder after heating-treated at 600-1200° C.

Preferably, the metallic oxide micro-powder is Al₂O₃ micro-powder.

Preferably, during melting, melting the raw material under vacuum or argon protection with induction heating for forming an alloy, refining at 1400-1470° C. before casting the alloy in a melted state onto a rotation roller with a water cooling function with a rotation speed of 1-10 m/s through a tundish, and cooling the alloy with the rotation roller for forming alloy flakes, wherein after leaving the rotation roller, the alloy flakes drop to a rotation disk for secondary cooling; outputting the alloy flakes after being cooled.

More preferably, during melting, melting the raw material under vacuum or argon protection with induction heating for forming an alloy, refining at 1400-1470° C. before casting the alloy in a melted state onto a rotation roller with a water cooling function with a rotation speed of 1-10 m/s through a tundish, and cooling the alloy with the rotation roller for forming alloy flakes, wherein after leaving the rotation roller, the alloy flakes drop; crushing the alloy flakes and sending into a receiving tank, then cooling the alloy flakes with inert gas.

Even more preferably, during melting, melting the raw material under vacuum or argon protection with induction heating for forming an alloy, refining at 1400-1470° C. before casting the alloy in a melted state onto a rotation roller with a water cooling function with a rotation speed of 1-4 m/s through a tundish, and cooling the alloy with the rotation roller for forming alloy flakes, wherein a temperature of the alloy flakes is 400-700° C., after leaving the rotation roller, the alloy flakes drop to a rotation plate for secondary cooling to a temperature of less than 400° C.; crushing the alloy flakes and then keeping the temperature at 200-600° C. before cooling the alloy flakes with inert gas.

Preferably, during melting the Ce-HR-Fe—B-Mb alloy, melting a Ce-HR-Fe—B-Mb raw material under vacuum or argon protection with induction heating for forming an alloy, refining before casting the alloy in a melted state onto a water-cooled mould for forming an alloy ingot, or onto a rotation roller with a water cooling function through a tundish and cooling the alloy with the rotation roller for forming alloy flakes; then crashing the alloy ingot or the alloy flakes into alloy blocks with a side length less than 10 mm, and adding the alloy blocks into a water-cooled cooper crucible of an arc-heating vacuum quenching furnace under an argon atmosphere, melting the alloy blocks with an electric arc for forming alloy liquid, contacting the melted alloy liquid with a periphery of a water-cooled high-speed rotating molybdenum wheel, in such a manner that the melted alloy liquid is thrown out for forming the Ce-HR-Fe—B-Mb alloy in a shape of fiber; wherein an average grain size of the alloy is 0.6-0.9 μm.

Preferably, during melting the Ce-HR-Fe—B-Mb alloy, melting a Ce-HR-Fe—B-Mb raw material under vacuum or argon protection with induction heating for forming an alloy, refining before casting the alloy in a melted state onto a rotation roller with a water cooling function through a tundish, and cooling the alloy with the rotation roller for forming alloy flakes; then crashing the alloy flakes into alloy blocks with a side length less than 10 mm, and adding the alloy blocks into a water-cooled cooper crucible of an arc-heating vacuum furnace under an argon atmosphere, melting the alloy blocks with an electric arc for forming alloy liquid, contacting the melted alloy liquid with a periphery of a water-cooled high-speed rotating molybdenum wheel, in such a manner that the melted alloy liquid is thrown out for forming the Ce-HR-Fe—B-Mb alloy in a shape of fiber; wherein an average grain size of the alloy flakes is 0.6-1.9 μm.

Preferably, the average grain size of the Ce-LR-Fe—B-Ma alloy is 2-3 μm. Preferably, the average grain size of the Ce-HR-Fe—B-Mb alloy is 0.6-1.9 μm.

According to the present invention, by improving ingredient of the magnet and manufacturing method, the magnetic performance is significantly increased. Especially, coercivity and magnetic energy product are greatly improved and increased. Under the same coercivity condition, amount of heavy rare earth used is significantly decreased, which saves rare earth resource which is rare. Because the NdFeB rare earth permanent magnet is easy to be oxidized, application thereof in fields such as automobile and wind powder is badly affected. With the present invention, weight loss is significantly decreased, antioxidant ability of the magnet is improved, and an application range of the NdFeB rare earth permanent magnet is widened.

Residual magnetism and coercivity of Ce₂Fe₁₄B are obviously lower than the ones of Nd₂Fe₁₄B, Pr₂Fe₁₄B, Dy₂Fe₁₄B and Tb₂Fe₁₄B. Especially, the coercivity is much lower. Therefore, it is generally recognized that adding Ce will lower magnetic performance. However, according to the present invention, a novel manufacturing method and technology are disclosed, which increases residual magnetism, coercivity, magnetic energy product and anti-corrosive ability of the magnet by adding Ce.

These and other objectives, features, and advantages of the present invention will become apparent from the following detailed description, the accompanying drawings, and the appended claims.

### DETAILED DESCRIPTION OF THE PREFERRED EMBODIMENT

Referring to preferred embodiments, the present invention is further illustrated.

### Preferred Embodiment 1

According to the preferred embodiment 1, respectively melting 600 Kg Ce-LR-Fe—B-Ma alloy and Ce-HR-Fe—B-Mb alloy selected from Table 1, casting the alloy in a melted state onto a rotation copper roller with a water cooling function, so as to be cooled for forming alloy flakes; during melting, adjusting a cooling speed of the Ce-LR-Fe—B-Ma alloy and the Ce-HR-Fe—B-Mb alloy by adjusting a rotation speed of the rotation copper roller; wherein an average grain size of the Ce-LR-Fe—B-Ma alloy is 2.8 μm and an average grain size of the Ce-HR-Fe—B-Mb alloy is 1.8 μm; selecting the Ce-LR-Fe—B-Ma alloy flakes and the Ce-HR-Fe—B-Mb alloy flakes with a ratio in Table 1 for hydrogen decrepitating; after hydrogen decrepitating, sending the alloy flakes and oxides with a ratio as shown in Table 1 into a mixer; mixing under nitrogen protection for 60 min before powdering with jet milling; sending the powder from the cyclone collector and the super-fine powder from the filter into a post-mixer for being post-mixed, wherein post-mixing is provided under nitrogen protection with a mixing time of 90 min; an oxygen content in protection atmosphere is less than 100 ppm; then sending into a nitrogen protection magnetic field pressing machine for pressing, wherein an orientation magnetic field strength is 1.8 T, an in-cavity temperature is 3° C., a size of a magnet is 40×30×20 mm, and an orientation direction is a 20 size direction; packaging in a protection tank after pressing, then outputting for isostatic pressing; sending into a sintering furnace for pre-sintering, wherein a pre-sintering temperature is kept at 940° C. for 15 h and a pre-sintering density is 7.3 g/cm³; then sintering, firstly ageing and secondly ageing, wherein a sintering temperature is kept at 1070° C. for 1 h; obtaining a magnetic block for being machined, then measuring magnetic performance and weight loss, recording results in Table 1, wherein according to detection, a weight percentage component of the sintered magnet is: Ce_{0.5}(Nd_{0.7}Pr_{0.3})₂₉Dy_{1.0}B_{0.9}Al_{0.1}Co_{1.2} Cu_{0.15}Feᵣₑₛₜ; magnetic energy product, coercivity and weight loss results are also recorded in Table 1.

### Contrast Example 1

According to the contrast example 1, selecting a magnet of (Nd_{0.7}Pr_{0.3})_{29.5}Dy_{1.0}B_{0.9}Al_{0.1}Co_{1.2}Cu_{0.15}Feᵣₑₛₜ as shown in Table 2, melting the alloy, casting the alloy in a melted state onto a rotation copper roller with a water cooling function, so as to be cooled for forming alloy flakes, then processing the alloy with hydrogen decrepitating, powdering with jet milling, magnetic field pressing, isostatic pressing, sintering and two-stage ageing; milling before detecting magnetic performance and weight loss, recording results in Table 1.

Compared with the magnet component in the preferred embodiment 1, the magnet component in the contrast example 1 is the same. However, performance such as magnetic energy product, coercivity and weight loss in the preferred embodiment 1 is significantly higher than the one in the contrast example 1.

If a Co content is changed while the others in the preferred embodiment 1 are kept, when 0≦Co≦5, metallic oxide is 0.01-0.05%, and magnetic performance changes within a range of 4% while the Co content increases, resulting in that the magnetic performance is significantly higher than the one in the contrast example 1. Preferably, 0≦Co≦3, wherein the magnetic performance is less changed. More preferably, 1.0≦Co≦2.4, wherein the magnetic performance is even less changed, and a change range is less than 2%. If the Co content is kept and a Cu content is changed, when 0≦Cu≦0.3, metallic oxide is 0.01-0.05%, and magnetic performance changes within a range of 3% while the Co content changes, resulting in that the magnetic performance is significantly higher than the one in the contrast example 1. Preferably, 0.1≦Cu≦0.3, wherein magnetic performance changes within a range of 2% while the Co content changes. More preferably, 0.1≦Cu≦0.2, wherein magnetic performance changes within a range of 1% while the Co content changes. According to experiments, when both Co and Cu are added with 0.8≦Co≦2.4 and 0.1≦Cu≦0.2, magnetic performance and anti-corrosive ability are best. Preferably, both Co and Cu are added with 0.8≦Co≦2.4 and 0.1≦Cu≦0.2.

Material components and experiment methods in the preferred embodiment 1 are kept, and only kind and content of the metallic oxide are changed. It is experimentally proved that when the metallic oxide micro-powder is Al₂O₃ with a content of 0.01-0.05%, the magnetic performance increases while the content increases; when the content is 0.01-0.08%, the magnetic performance keeps higher than the one with a content of 0.01%, wherein when the metallic oxide micro-powder is Dy₂O₃ or Tb₂O₃, conditions are the same. Performance of Dy₂O₃ is higher than the one of Al₂O₃, and performance of Tb₂O₃ is higher than the one of Dy₂O₃. Preferably, the content of the metallic oxide micro-powder is 0.01-0.05%; more preferably, the content of the metallic oxide micro-powder is 0.02-0.03%. Preferably, the metallic oxide micro-powder is Al₂O₃; more preferably, the metallic oxide micro-powder is Dy₂O₃; and even more preferably, the metallic oxide micro-powder is Tb₂O₃. By adding more than one kind of the metallic oxide micro-powder, magnetic performance is further increased. Preferably, the metallic oxide micro-powder is Dy₂O₃ and Al₂O₃, more preferably, the metallic oxide micro-powder is Al₂O₃ and Tb₂O₃, or Tb₂O₃ and Dy₂O₃; and even more preferably, the metallic oxide micro-powder is Dy₂O₃, Tb₂O₃ and Al₂O₃.

### Preferred Embodiment 2

According to the preferred embodiment 2, respectively melting 600 Kg Ce-LR—Fe—B-Ma alloy and Ce-HR-Fe—B-Mb alloy selected from Table 1, casting the alloy in a melted state onto a rotation copper roller with a water cooling function, so as to be cooled for forming alloy flakes; during melting, adjusting a cooling speed of the Ce-LR-Fe—B-Ma alloy and the Ce-HR-Fe—B-Mb alloy by adjusting a rotation speed of the rotation copper roller; wherein an average grain size of the Ce-LR-Fe—B-Ma alloy is 2.3 μm and an average grain size of the Ce-HR-Fe—B-Mb alloy is 1.3 μm; selecting the Ce-LR-Fe—B-Ma alloy flakes and the Ce-HR-Fe—B-Mb alloy flakes with a ratio in Table 1 for hydrogen decrepitating; after hydrogen decrepitating, sending the alloy flakes and oxides with a ratio as shown in Table 1 into a mixer; mixing under nitrogen protection for 40 min before powdering with jet milling; sending the powder from the cyclone collector and the super-fine powder from the filter into a post-mixer for being post-mixed, wherein post-mixing is provided under nitrogen protection with a mixing time of 70 min; an oxygen content in protection atmosphere is less than 50 ppm; then sending into a nitrogen protection magnetic field pressing machine for pressing, wherein an orientation magnetic field strength is 1.8 T, an in-cavity temperature is 4° C., a size of a magnet is 40×30×20 mm, and an orientation direction is a 20 size direction; packaging in a protection tank after pressing, then outputting for isostatic pressing; sending into a sintering furnace for pre-sintering, wherein a pre-sintering temperature is kept at 910° C. for 10 h and a pre-sintering density is 7.2 g/cm³; then sintering, firstly ageing and secondly ageing, wherein a sintering temperature is kept at 1060° C. for 1 h; obtaining a magnetic block for being machined, then measuring magnetic performance and weight loss, recording results in Table 1, wherein according to detection, a weight percentage component of the sintered magnet is: Ce₁(Nd_{0.75}Pr_{0.25})₂₄Dy₄Tb₂Co₁Cu_{0.1}B_{0.95}Al_{0.2}Ga_{0.1}Feᵣₑₛₜ; magnetic energy product, coercivity and weight loss results are also recorded in Table 1.

### Contrast Example 2

Selecting (Nd_{0.75}Pr_{0.25})₂₅Dy₄Tb₂Co₁Cu_{0.1}B_{0.95}Al_{0.2}Ga_{0.1}Feᵣₑₛₜ as shown in Table 2 for experiment, wherein an experiment method thereof is the same as the one in the contrast example 2; recording results in Table 1.

Generally, if Pr or Nd is displaced by Ce, magnetic performance will significantly drops. Referring to Table 1, when 1% Ce displaces 1%(Nd_{0.75}Pr_{0.25}), the method according to the present invention greatly increases magnetic performance. If a Ce content is changed while the others are kept, it is experimentally illustrated that when 0≦Ce≦2.4, magnetic performance and anti-corrosive ability are still; when 2.5≦Ce≦3, magnetic performance and anti-corrosive ability are slightly decreased; when 3.1≦Ce≦4.5, magnetic performance and anti-corrosive ability are decreased less than 3%; and when 5≦Ce≦9, magnetic performance and anti-corrosive ability are decreased less than 5%. Preferably, 5≦Ce≦9; more preferably, 3.1≦Ce≦4.5; even more preferably, 2.5≦Ce≦3; and extremely preferably, 0≦Ce≦2.4.

If La is used instead of Ce for experiment, i.e. selecting La₁(Nd_{0.75}Pr_{0.25})₂₄Dy₄Tb₂Co₁Cu_{0.1}B_{0.95}Al_{0.2}Ga_{0.1}Feᵣₑₛₜ for experiment, conditions are the same. Preferably, 5≦La≦9; more preferably, 3.1≦La≦4.5; even more preferably, 2.5≦La≦3; and extremely preferably, 0≦La≦2.4.

### Preferred Embodiment 3

According to the preferred embodiment 3, respectively melting 600 Kg Ce-LR—Fe—B-Ma alloy and Ce-HR-Fe—B-Mb alloy selected from Table 1, casting the alloy in a melted state onto a rotation copper roller with a water cooling function, so as to be cooled for forming alloy flakes; during melting, adjusting a cooling speed of the Ce-LR-Fe—B-Ma alloy and the Ce-HR-Fe—B-Mb alloy by adjusting a rotation speed of the rotation copper roller; wherein an average grain size of the Ce-LR-Fe—B-Ma alloy is 2.8-3.2 μm and an average grain size of the Ce-HR-Fe—B-Mb alloy is 2.1-2.4 μm; selecting the Ce-LR—Fe—B-Ma alloy flakes and the Ce-HR-Fe—B-Mb alloy flakes with a ratio in Table 1 for hydrogen decrepitating; after hydrogen decrepitating, sending the alloy flakes and oxides with a ratio as shown in Table 1 into a mixer; mixing under nitrogen protection for 90 min before powdering with jet milling; sending the powder from the cyclone collector and the super-fine powder from the filter into a post-mixer for being post-mixed, wherein post-mixing is provided under nitrogen protection with a mixing time of 60 min; an oxygen content in protection atmosphere is less than 150 ppm; then sending into a nitrogen protection magnetic field pressing machine for pressing, wherein an orientation magnetic field strength is 1.5 T, a size of a magnet is 40×30×20 mm, and an orientation direction is a 20 size direction; sending into a sintering furnace for pre-sintering, wherein a pre-sintering temperature is kept at 990° C. for 8 h and a pre-sintering density is 7.4 g/cm³; then sintering, firstly ageing and secondly ageing, wherein a sintering temperature is kept at 1080° C. for 1 h; obtaining a magnetic block for being machined, then measuring magnetic performance and weight loss, recording results in Table 1, wherein according to detection, a weight percentage component of the sintered magnet is: Ce_{1.5}(Nd_{0.8}Pr_{0.2})₂₀Dy₆Ho₂Gd₂Co_{2.4}Cu_{0.2}B_{1.0}Al_{0.3}Ga_{0.1}Zr_{0.1}Nb_{0.1}Feᵣₑₛₜ; magnetic energy product, coercivity and weight loss results are also recorded in Table 1.

### Contrast Example 3

According to the contrast example 3, selecting a magnet of (Nd_{0.8}Pr_{0.2})_{21.5}Dy₆Ho₂Gd₂Co_{2.4}Cu_{0.2}B_{1.0}Al_{0.3}Ga_{0.1}Zr_{0.1}Nb_{0.1}Feᵣₑₛₜ as shown in Table 2, melting the alloy, casting the alloy in a melted state onto a rotation copper roller with a water cooling function, so as to be cooled for forming alloy flakes, then processing the alloy with hydrogen decrepitating, powdering with jet milling, magnetic field pressing, isostatic pressing, sintering and two-stage ageing; milling before detecting magnetic performance and weight loss, recording results in Table 1.

Compared with the magnetic performance in the contrast example 3, magnetic energy product and coercivity in the preferred embodiment 3 are significantly higher than the one in the contrast example 3, which further illustrated the advantages of the present invention.

Referring to the preferred embodiments 1-3 and the contrast examples 1-3, it is illustrated that the present invention has significant advantages. Adding Al, Ga, Zr and Nb is greatly conducive to improvement of magnetic performance and anti-corrosive ability of the magnet. Preferably, 0≦Al≦0.6; preferably, 0≦Ga≦0.2; preferably, 0≦Zr≦0.3; and preferably, 0≦Nb≦0.3. More preferably, 0.1≦Al≦0.3; more preferably, 0.05≦Ga≦0.15; more preferably, 0.1≦Zr≦0.2; and more preferably, 1≦Nb≦0.2.

TABLE 1
component and performance in preferred embodiments and contrast examples

| | | preferred | contrast | preferred | contrast | preferred | contrast |
|---|---|---|---|---|---|---|---|
| group | | embodiment 1 | example 1 | embodiment 2 | example 2 | embodiment 3 | example 3 |
| LR-Fe—B-Ma | Pr | 9.15 | 9 | 7.5 | 5 | 6 | 4.3 |
| alloy | Nd | 21.35 | 21 | 22.5 | 20 | 24 | 17.2 |
| (Wt %) | La | | | | | | |
| | Ce | 0.5 | | 1.0 | | 1.5 | |
| | Dy | 0 | 1 | 0 | 4 | | 6 |
| | Tb | 0 | 0 | 0 | 2 | | |
| | Ho | | | | | | 2 |
| | Gd | | | | | | 2 |
| | Co | 1.0 | 1.0 | 1.2 | 1.2 | 2.4 | 2.4 |
| | Cu | 0.1 | 0.1 | 0.15 | 0.15 | 0.2 | 0.2 |
| | B | 0.9 | 0.9 | 0.95 | 0.95 | 1.0 | 1.0 |
| | Al | 0.1 | 0.1 | 0.2 | 0.2 | 0.3 | 0.3 |
| | Ga | | | 0.1 | 0.1 | 0.1 | 0.1 |
| | Zr | | | | | 0.1 | 0.1 |
| | Nb | | | | | 0.1 | 0.1 |
| | Fe | the rest | the rest | the rest | the rest | the rest | the rest |
| | alloy ratio | 90% | 100% | 80% | 100% | 60% | 100% |
| HR-Fe—B-Mb | Dy | 10 | | 20 | | 15 | |
| alloy | La | | | | | | |
| (Wt %) | Ce | 0.5 | | 1 | | 1.5 | |
| | Pr | 6.15 | | 0.25 | | 1 | |
| | Nd | 14.35 | | 0.75 | | 4 | |
| | Tb | 0 | | 10 | | | |
| | Ho | | | | | 5 | |
| | Gd | | | | | 5 | |
| | Co | 1.0 | | 1.2 | | 2.4 | |
| | Cu | 0.1 | | 0.15 | | 0.2 | |
| | B | 0.9 | | 0.95 | | 1.0 | |
| | Al | 0.1 | | 0.2 | | 0.3 | |
| | Ga | | | 0.1 | | 0.1 | |
| | Zr | | | | | 0.1 | |
| | Nb | | | | | 0.1 | |
| | Fe | | | the rest | | the rest | |
| | alloy ratio | 10% | 0 | 20% | 0 | 40% | 0 |
| oxide | Dy₂O₃ | 0.01 | | 0.02 | | 0.03 | |
| micro- | Tb₂O₃ | | | 0.01 | | 0.01 | |
| powder | A1₂O₃ | 0.01 | | | | 0.01 | |
| (Wt %) | total | 0.02 | | 0.03 | | 0.05 | |

| | | | | | | |
|---|---|---|---|---|---|---|
| magnetic energy product (MGOe) | 47 | 46 | 43 | 38 | 30 | 27 |
| coercivity (KOe) | 21 | 15 | 33 | 27 | 36 | 31 |
| magnetic energy product + coercivity | 68 | 61 | 76 | 65 | 66 | 58 |
| weight loss (mg/cm²) | 2 | 4 | 2 | 6 | 3 | 5 |

TABLE 2
component of rare earth permanent magnetic alloy in contrast examples

| group | component |
|---|---|
| contrast example 1 | (Nd_{0.7}Pr_{0.3})_{29.5}Dy_{1.0}B_{0.9}Al_{0.1}Co_{1.2}Cu_{0.15}Feᵣₑₛₜ |
| contrast example 2 | (Nd_{0.75}Pr_{0.25})₂₅Dy₄Tb₂Co₁Cu_{0.1}B_{0.95}Al_{0.2}Ga_{0.1}Feᵣₑₛₜ |
| contrast example 3 | (Nd_{0.8}Pr_{0.2})_{21.5}Dy₆Ho₂Gd₂Co_{2.4}Cu_{0.2}B_{1.0}Al_{0.3}Ga_{0.1}Zr_{0.1}Nb_{0.1}Feᵣₑₛₜ |

It is further illustrated by the preferred embodiments and the contrast example that the method and the device according to the present invention significantly improve magnetic energy product, conercivity and anti-corrosive ability of the magnet. By double-alloy melting, one-stage crashing, and adding metallic oxide micro-powder during jet milling, the present invention improves the powder structure and forms a milled metallic oxide surface, which prevents the magnetic powder from being further oxidized. The Ce-HR-Fe—B-Mb alloy powder is adsorbed around the Ce-LR-Fe—B-Ma alloy powder, which is alloyed during sintering for forming a special metallic phase structure of the present invention. Compared with Dy infiltration technology, the present invention is not limited by shapes and sizes of magnets. Therefore, the method and the technology have a brilliant future.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for manufacturing a NdFeB rare earth permanent magnet containing Ce, wherein a raw material comprises a Ce-LR-Fe—B-Ma alloy, a Ce-HR-Fe—B-Mb alloy, and metallic oxide micro-powder, the LR comprises more than two rare earth elements except Ce and at least comprises Nd and Pr; wherein the HR comprises one or more rare earth elements except Ce and at least comprises Dy or Tb; wherein the Ma is selected from a group consisting of Al, Co, Nb, Ga, Zr and Cu; wherein the Mb is selected from a group consisting of Al, Co, Nb, Ga, Zr, Cu and Mo; the method comprising steps of:
(1) melting the Ce-LR-Fe—B-Ma alloy which comprises:
melting a Ce-LR-Fe—B-Ma raw material under vacuum or argon protection with induction heating for forming an alloy, refining before casting the alloy in a melted state onto a rotation roller with a water cooling function through a tundish, and cooling the alloy with the rotation roller for forming alloy flakes, wherein an average grain size of the alloy flakes is 2.0-3.5 μm;
(2) melting the Ce-HR-Fe—B-Mb alloy which comprises:
melting a Ce-HR-Fe—B-Mb raw material under vacuum or argon protection with induction heating for forming an alloy, refining before casting the alloy in a melted state onto a rotation roller with a water cooling function through a tundish, and cooling the alloy with the rotation roller for forming alloy flakes, wherein an average grain size of the alloy flakes is 0.1-2.9 μm;
(3) providing hydrogen decrepitating which comprises:
sending the Ce-LR-Fe—B-Ma alloy and the Ce-HR-Fe—B-Mb alloy into a vacuum hydrogen decrepitation device, evacuating before inputting hydrogen for hydrogen absorption, wherein a hydrogen absorption temperature is 100-300° C.; heating after hydrogen absorption and evacuating for dehydrogenating, wherein a dehydrogenating temperature is 350-900° C., then cooling the alloys;
(4) adsorbing with the metallic oxide micro-powder and powdering which comprises:
adding the Ce-LR-Fe—B-Ma alloy treated with hydrogen decrepitating, the Ce-HR-Fe—B-Mb alloy treated with hydrogen decrepitating and the metallic oxide micro-powder into a mixer for mixing, wherein lubricant and anti-oxidant are added while mixing, mixing is provided under nitrogen protection; powdering with jet milling after mixing for producing alloy powder; and
(5) providing magnetic field pressing, sintering and ageing which comprises:
processing the alloy powder with magnetic field pressing under nitrogen protection; then sintering and ageing under vacuum or argon protection for producing the NdFeB rare earth permanent magnet.

2. The method, as recited in claim 1, wherein the metallic oxide micro-powder is Dy₂O₃ micro-powder.

3. The method, as recited in claim 1, wherein the metallic oxide micro-powder is Al₂O₃ micro-powder.

4. The method, as recited in claim 1, wherein the metallic oxide micro-powder is selected from a group consisting of Dy₂O₃, Tb₂O₃ and Al₂O₃.

5. The method, as recited in claim 1, wherein after vacuum dehydrogenation, inputting hydrogen with a pre-determined amount within a temperature range of 100-600° C., then cooling the alloys; or inputting hydrogen with the pre-determined amount during mixing.

6. The method, as recited in claim 1, wherein the step (2) specifically comprising steps of: melting a Ce-HR-Fe—B-Mb raw material under vacuum or argon protection with induction heating for forming an alloy, refining before casting the alloy in a melted state onto a rotation roller through a tundish with a water cooling function, and cooling the alloy with the rotation roller for forming alloy flakes; then crashing the alloy flakes into alloy blocks with a side length less than 10 mm, and adding the alloy blocks into a water-cooled cooper crucible of an arc-heating vacuum furnace under an argon atmosphere, melting the alloy block with an electric arc for forming alloy liquid, contacting melted alloy liquid with a periphery of a water-cooled high-speed rotating molybdenum wheel, in such a manner that the melted alloy liquid is thrown out for forming the Ce-HR-Fe—B-Mb alloy in a shape of fiber; wherein an average grain size of the alloy is 0.6-1.9 μm;

7. The method, as recited in claim 1, wherein during powdering with jet milling, mixing the powder collected by a cyclone collector with fine powder outputted through an outputting pipeline of the cyclone collector under nitrogen protection, wherein the mixed powder is for magnetic field pressing.

8. A NdFeB rare earth permanent magnet containing Ce, wherein the NdFeB rare earth permanent magnet has a composition comprising Ce 0-9 wt. %; Ra 19-32 wt. %; B 0.8-1.2 wt. %; M 0-4.0 wt. %; Rb 0.5-10 wt. %; La+Ra+Rb 30-33 wt. %; Fe and impurity;
wherein the Ra comprises at least two rare elements selected from a group consisting of Ce, Pr and Nd, and the Ra at least comprises Nd;
the Rb is selected from a group consisting of Dy, Tb, Ho and Gd;
the M is selected from a group consisting of Al, Co, Nb, Ga, Zr, Cu and Mo;
wherein the NdFeB rare earth permanent magnet containing Ce comprises a composite main phase and a grain boundary phase, wherein the composite main phase has a core of a PR₂(Fe_{1-x-y}CoₓAl_{y})₁₄B phase; a ZR₂(Fe_{1-w-n}Co_{w}Alₙ)₁₄B main phase surrounds the PR₂(Fe_{1-x-y}CoₓAl_{y})₁₄B main phase, and there is no grain boundary phase therebetween; wherein the ZR refers to a group of main phase rare earth elements whose heavy rare earth contents are higher than an average heavy rare earth content; the PR refers to a group of main phase rare earth elements whose heavy rare earth contents are lower than the average heavy rare earth content; wherein 0≦x≦0.3, 0≦y≦0.2, 0≦w≦0.3, 0≦n≦0.2; Ra oxide micro-particles and oxidized Nd micro-particles exist in the grain boundary phase; and an oxygen content of the grain boundary phase is higher than an oxygen content of the main phase.

9. The NdFeB rare earth permanent magnet containing Ce, as recited in claim 8, wherein an average grain size is 6-15 μm.

10. The NdFeB rare earth permanent magnet containing Ce, as recited in claim 8, wherein oxidized Ce micro-particles and oxidized Nd micro-particles exist in the grain boundary phase.

11. The NdFeB rare earth permanent magnet containing Ce, as recited in claim 8, wherein oxidized Ce₂O₃ micro-particles and oxidized Nd₂O₃ micro-particles exist in the grain boundary phase.

12. The NdFeB rare earth permanent magnet containing Ce, as recited in claim 8, wherein the Ra comprises a rare earth element Pr and a rare earth element Nd, and Pr/Nd is 0.25-0.45.

13. The NdFeB rare earth permanent magnet containing Ce, as recited in claim 8, wherein a Ce content is 0.6-2.4 wt. %.
